(19) United States
(12) Patent Application Publication
(10) Pub. No.: US 2003/0144785 A1
(43) Pub. Date: Jul. 31, 2003

(54) System and method for monitoring the properties of a tire

(76) Inventors: Jost Brachert, Ditzingen (DE); Ulrich Hessmert, Schwieberdingen (DE); Norbert Polzin, Zaberfeld (DE); Thomas Sauter, Remseck (DE); Helmut Wandel, Markgroeningen (DE); Werner Hess, Stuttgart (DE); Klaus Ries-Mueller, Bad Rappenau (DE)

Correspondence Address: KENYON & KENYON, ONE BROADWAY, NEW YORK, NY, 10004, US

(21) Appl. No.: 10/220,533

(22) PCT Filed: Dec. 21, 2001
(86) PCT No.: PCT/DE01/04857

(30) Foreign Application Priority Data
Dec. 30, 2000 (DE) 100-65-767.2
Jun. 12, 2001 (DE) 101-28-284.2

(51) Int. Cl. G06F 17/00

(52) U.S. Cl. 701/74

(57) ABSTRACT

A system for monitoring the properties of at least one tire (12) on a vehicle (36) is described, means being provided on the tire to store information representing properties of the tire (12) and sensors (20, 22) being provided for acquiring the information. A method for monitoring properties of at least one tire is also described.

The present invention relates to a system for monitoring properties of at least one tire on a vehicle. The invention also relates to a method for monitoring the properties of at least one tire on a vehicle.

### BACKGROUND INFORMATION

The type of tires of a motor vehicle has an influence on the driving response. For example, incorrect tires may result in critical driving states in motor vehicles. For this reason, an endeavor is made to obtain information concerning the tires and to analyze it via appropriate evaluation electronics. Finally, the driving safety of motor vehicles should be improved in this manner.

Vehicle dynamics control systems are known for regulating the driving response of a motor vehicle. Antilock braking systems (ABS), traction control systems (TCS) and the electronic stability program (ESP) are known. Acquisition of the speeds of the individual wheels of a motor vehicle via sensors and taking the acquired wheel speeds into consideration in controlling and/or regulating the driving response of the motor vehicle is also known. Although good results are being obtained with the known methods and systems, there is an interest, with respect to traffic safety in particular, to enhance the methods and systems according to the definition of the species.

In connection with the sensors provided as known heretofore, it is further known that various tire manufacturers are planning the future introduction of ‘smart’ tires. In doing so, novel sensors and evaluation circuits may be affixed directly to the tire. The use of such tires permits additional functions such as, for example, the measurement of the torque applied to the tire transversally and longitudinally to the direction of travel, the tire pressure or the tire temperature. In this connection, tires may be provided, for example, in which magnetized areas or strips having field lines preferably running in the circumferential direction are incorporated in each tire, the magnetized areas or strips acting as acquiring elements. The acquiring elements therefore rotate at wheel speed. Corresponding pickup devices are preferably affixed to the body at different points in relation to the wheel. This makes it possible to obtain an inner measurement signal and an outer measurement signal. A rotation of the tire may then be recognized via the changing polarity of the measurement signal(s) in the circumferential direction. It is possible to calculate the wheel speed, for example, from the rolling circumference and the change over time of the inner measurement signal and the outer measurement signal, for example.

### SUMMARY OF THE INVENTION

The invention builds on the system of the definition of the species in that means are provided on the tires to store information, the information representing properties of the tire and that sensors are provided for acquiring the information. In this manner, it is possible to obtain information concerning the tires which may be utilized in many ways.

In this connection, the system of the definition of the species is enhanced advantageously in particular in that the driving response is controlled based on the information acquired by the sensors. This makes it possible to have a direct influence on the driving response of the tire as a function of the information stored on the tire.

It is to be preferred in particular that the driving response is regulated on the basis of the information acquired by the sensors. The information may thus be used in connection with controlled variables or by itself as a controlled variable of a vehicle dynamics control system.

In another advantageous embodiment of the system of the present invention, the system is enhanced by implementing the means to store the information by modifying the acquiring elements of a tire sensor arranged on the tires and by providing a vehicle dynamics control system to evaluate the information, the vehicle dynamics control system processing the information from tire sensors. The tire sensors described in connection with the related art have, as mentioned, magnetized strips. It is possible to record tire-specific information, for example, on these magnetized strips by encoding the magnetic areas. The encoding may be accomplished in such a manner that the signals picked up by the sensors lack one or more flanks. It is also conceivable that magnetic areas are subdivided to produce additional flanks in the signals. A modified control system response may be assigned to a vehicle dynamics control system on the basis of this additional information.

It is preferred in particular that the information represents the slip requirements of the tire. It is possible in this manner to optimize the control performance of slip control systems since the control sensitivity of different tire types may be adapted.

It is useful in particular that the information represents the maximum allowed vehicle longitudinal speed for the tire. This improves driving safety since in the case of winter tires, for example, exceeding the maximum speed allowed for the winter tire is avoided by regulation or control.

Similarly, it may be advantageous that the information represents the manufacturing date of the tire. The manufacturing date of a tire may also be important with respect to driving safety so that it may be considered in an appropriate manner in the control response of a vehicle dynamics control system.

Furthermore, the possibility of determining, as a function of the information, if the tire is approved for the vehicle may be provided. This relates to the tire size in particular to prevent a vehicle from being operated with unapproved tires.

It is also useful that the tire wear may be determined as a function of the information. This has a strong influence on the driving response of a vehicle so that this information may also be evaluated in an appropriate manner.

The system of the present invention is enhanced in a particularly useful manner in that a speed limiting device may be activated as a function of the information. Such a speed limiting device was already mentioned in connection with the fact that a maximum allowed vehicle speed for the tire is recorded on the tire. However, such a speed limiting device may also be appropriately activated as a function of the manufacturing date and the tire wear.

The possibility of activating a vehicle immobilizing device as a function of the information may also be advantageously provided. Such a vehicle immobilizing device is meaningful in particular if the information stored on the tire shows that the tire is not approved for the vehicle.

It is also useful in particular that driver information may be output as a function of the information. It is thus possible for the driver to take necessary actions, for example, to have a tire changed as a function of the manufacturing date of the tire.

In another preferred embodiment of the system according to the present invention, an electronic memory module that may be affixed to the tire is provided for the storage of the information. Such a memory module may be implemented, for example as an EEPROM (electrically erasable programmable read only memory). The memory module may, for example, be read from a tire control unit using a communication interface. The tire control unit may in turn communicate with the engine management system via a transmission interface (via CAN, for example). The engine management system may then influence the engine, transmission and/or brakes. In this connection, it should be stressed in particular that the tire-specific information provided with the tire in a memory module may also be combined with other information, which is determined, for example, by a tire sensor. It is also conceivable that the information stored at the tire in any manner, which is specific to the tire, may be combined with information determined by a wheel bearing sensor. Such wheel bearing sensors are implemented in such a way, for example, that microsensors are installed in the rotating part of a wheel bearing. Forces and accelerations as well as the rotational speed are measured by a microsensor that is affixed to the movable part of the wheel bearing. These data are compared with electronically stored basic patterns. It is similarly conceivable that microsensors may also be installed on the static part of the wheel bearing. The data measured by the microsensors affixed to the movable part of the wheel bearing may then be compared with the data measured on the static part of the wheel bearing.

It is in addition useful to enhance the system of the present invention in such a manner that an applicable service life model of the tire is inferred from the information, that values of variables that influence the life of the tire are acquired during the life of the tire, that the values are used as input values for the service life model, and that the use of the service life model makes it possible to decide if the tire has exceeded its service life. It is thus possible to indicate the necessity of changing a tire as a function of mileage, tire load and tire properties. In doing so, parameters may be generated that represent, for example, a braking intervention so that such events that influence the life of a tire may be considered. Similarly, the tire temperature may be considered in determining the service life in connection with the service life model.

The invention builds on the method according to the definition of the species in that information representing the properties of the tire is stored on the tire and that the information is acquired by sensors. In this manner, the advantages of the system of the present invention are implemented in the method. In the embodiments of the method specified below, the advantages and features of the corresponding system embodiments are to be noted.

In this connection, the method according to the definition of the species is enhanced in a particularly advantageous manner in that the driving response of the vehicle is controlled based on the information acquired by the sensors.

It is to be preferred in particular that the driving response of the vehicle is regulated based on the information acquired by the sensors.

In another advantageous embodiment of the method of the present invention, the latter is enhanced in that the information is stored by modifying the acquiring elements of a tire sensor situated on the tires and that the information is evaluated in a vehicle dynamics control system that processes the information from tire sensors.

It is to be preferred in particular that the information represents the slip requirements of the tire.

It is useful in particular that the information represents the maximum speed allowed for the tire.

Similarly, it may be advantageous that the information represents the manufacturing date of the tire.

It may also be provided that it is possible to determine, as a function of the information, if the tire is approved for the vehicle.

It is also useful that the tire wear may be determined as a function of the information.

The method of the present invention is enhanced in a particularly useful manner in that a speed limiting device is activated as a function of the information.

It is also advantageous that a vehicle immobilizing device may be activated as a function of the information.

It is also useful in particular that driver information may be output as a function of the information.

In another preferred embodiment of the method of the present invention, it is provided that the information is stored in an electronic memory module affixed to the tire.

It is also useful to enhance the method of the present invention in such a manner that an applicable service life model of the tire is inferred from the information, that values of variables that influence the life of the tire are acquired during the life of the tire, that the values are used as input values for the service life model, and that the use of the service life model makes it possible to decide if the tire has exceeded its service life.

The present invention is based on the knowledge that it is possible to improve driving safety considerably by considering tire-specific information in a regulating or control system. It is useful in particular to note that this tire-specific information may be combined with other information representing, for example, wheel forces or wheel speeds.

### DRAWING

The invention will now be explained based on preferred embodiments with reference to the appended drawing in which:

FIG. 1 shows a block diagram of a system according to the present invention;

FIG. 2 shows a flow diagram of a method according to the present invention;

FIG. 3 shows a tire having a first structure of magnetic areas for use with a tire sidewall sensor system;

FIG. 4 shows a waveform of output signals of an arrangement according to FIG. 3;

FIG. 5 shows a tire having a second structure of magnetic areas for use with a system according to the present invention;

FIG. 6 shows a waveform of output signals of an arrangement according to FIG. 5;

FIG. 7 shows a tire having a third structure of magnetic areas for use with a system according to the present invention;

FIG. 8 shows a waveform of output signals of an arrangement according to FIG. 7;

FIG. 9 shows an overview of a system according to the present invention and

FIG. 10 shows a block diagram to illustrate the determination of a tire service life.

### DETAILED DESCRIPTION OF THE EMBODIMENTS

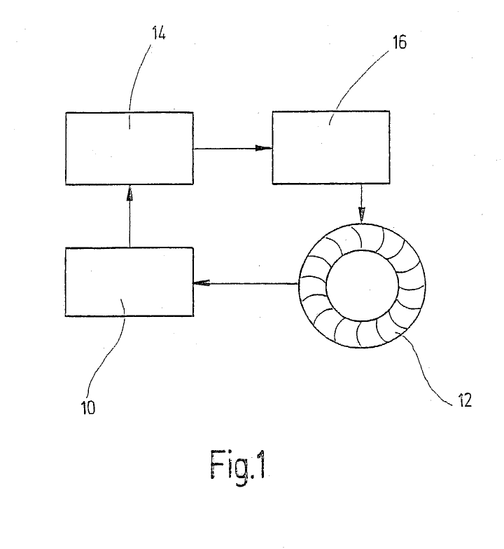

A block diagram of the system of the present invention is shown in FIG. 1. A sensor system 10 is assigned to a tire 12, this tire 12 representing several tires of a vehicle. Sensor system 10 is connected with a device 14 for evaluating measured values. This device 14 is connected with a regulating device 16, which is in turn capable of performing functions assigned to tire 12. Means (not shown) to store information are provided on tire 12. The means are tire-specific. The sensors of sensor system 10 are capable of reading out the tire-specific data of tire 12. The values determined in this manner are sent to a device 14 for evaluation of the data. In this unit 14, the slip requirement of tire 12, for example, is determined from the information of sensor system 14. These values, i.e., the slip requirement, for example, are now sent to a regulating device 16, where in addition to other values, they are considered in influencing the driving response of a vehicle. If need be, regulating device 16 therefore influences the torques, for example, of tire 12. Such influence may, for example, be via an engine intervention and/or a braking intervention.

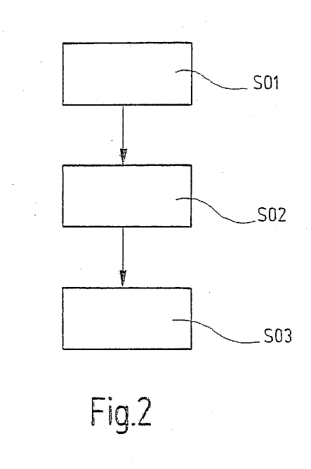

FIG. 2 shows a flow diagram of a method of the present invention. First, the meaning of the steps shown in FIG. 2 will be indicated:

S01: Acquisition of information.

S02: Determination of the slip requirement.

S03: Consideration of the slip requirement in the electronic stability program.

Information is acquired in step SO1. In addition to the information specific to the tire, this information may also include information with respect to the wheel forces occurring or, for example, the wheel speeds.

In step S02, the slip requirement of the tire is determined from the information acquired in step SO1. In other embodiments, a maximum speed, a manufacturing date, information concerning the tire size and/or information concerning tire wear, for example, are determined from the information acquired.

In step S03, the slip requirement, for example, is now considered to modify the electronic stability program accordingly. In the event a maximum speed is determined in step S02, the electronic stability program may be modified in step S03 in such a way that a maximum speed is set. This means that braking interventions occur if the maximum speed is exceeded.

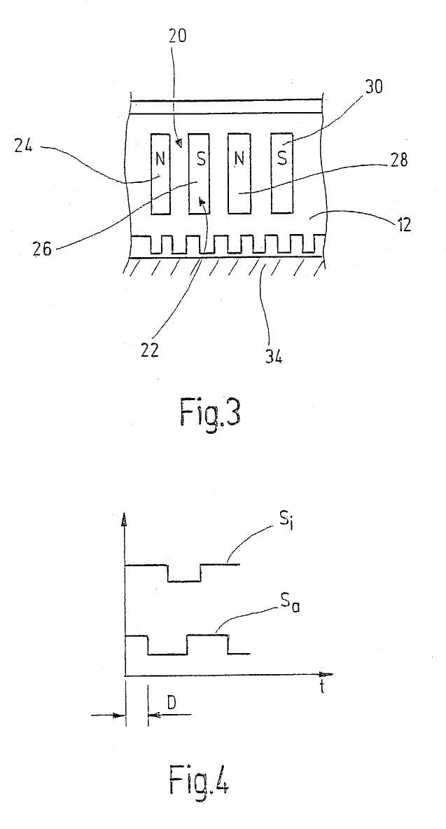

Different arrangements of magnetized strips in a tire sidewall and the corresponding sensor output signals are shown in FIGS. 3 through 8.

FIG. 3 is used initially to illustrate the basic principle of the tire sensor or tire/sidewall sensor. Magnetized surfaces 24, 26, 28, 30 (strips) having field lines preferably running the circumferential direction of tire 12 are incorporated in tire 12. The strips are magnetized by sections always in the same direction but with opposite orientation, i.e., with alternating polarity. Magnetized strips 24, 26, 28, 30 preferably run in the vicinity of the rim flange and in the vicinity of the contact area. Strips 24, 26, 28, 30 acting as acquiring elements therefore rotate at wheel speed. Sensors 20, 22 acting as pickup devices are affixed to the body at two or more different points in the direction of rotation and in addition have a different radial spacing from the axis of rotation. Sensor 20 picks up an inner signal Sᵢ; sensor 22 picks up an outer signal Sₐ.

Waveforms Sᵢ and Sₐ are shown in FIG. 4. A rotation of tire 12 is recognized via the changing polarity of the measurement signal preferably in the direction of rotation. It is possible to calculate the wheel speed from the rolling circumference and the change over time of signals Sᵢ and Sₐ. In addition, it is possible to infer wheel forces from the phase modulation and amplitude modulation of signals Sᵢ and Sₐ, for example, forces acting in the direction of rotation which exert a torsion on the tire or also contact forces of tire 12 on road surface 34.

Using the magnetic patterns in the sidewall of tire 12, it is possible to record additional information which is, for. example, tire-specific.

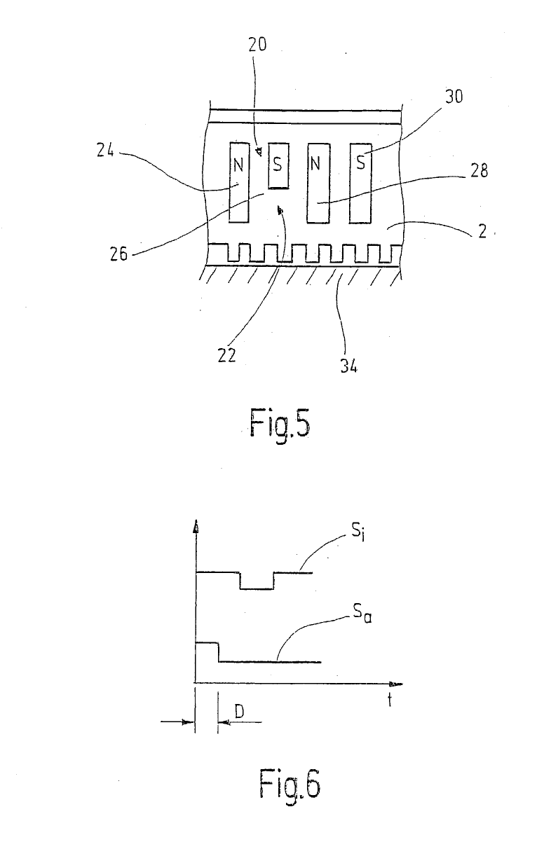

An example of the encoding of the magnetic pattern is shown in FIG. 5. The magnetic pattern is designed so that an encoding is present in such a manner that signal Sa lacks two flanks in the area shown. This makes a large number of encodings possible due to the large number of magnetized areas, for example, 48 areas over the circumference of the tire.

Modified signal Sa is shown in FIG. 6 while signal Sᵢ corresponds to signal Sᵢ shown in FIG. 4.

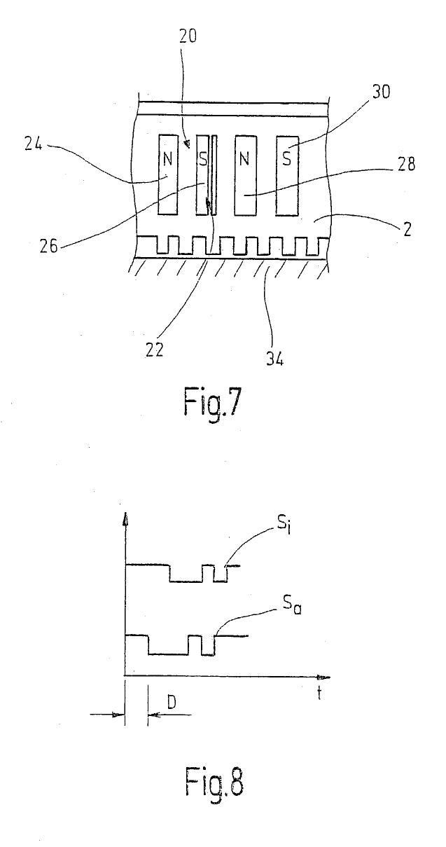

Another possibility for encoding the magnetic pattern may be explained using FIGS. 7 and 8. This possibility is that one or more magnetic strips are subdivided, strip 26 in this case. This results in signals such as those shown in FIG. 8.

Preferably, a modified control system response is now assigned to these different waveforms in a processing device. This will be explained using two examples.

If all flanks are present in signals Sᵢ and Sa, it is inferred from this that the tire is a summer tire. It follows from this that the slip requirement is relatively low. Accordingly, a low slip threshold is set.

If, however, deviations are present in signals Si and/or Sa, as shown in FIGS. 6 and 8, respectively, this may mean that M&S tires are mounted. An increased slip requirement is inferred from this. The slip thresholds are selected to be higher.

In this manner, the setting thresholds in the slip control algorithm (drive slip and brake slip) may be adjusted in such a way that an optimum control system performance is obtained, i.e., good traction and good stability with TCS and ESP as well as good stability with a short braking distance in the case of ABS.

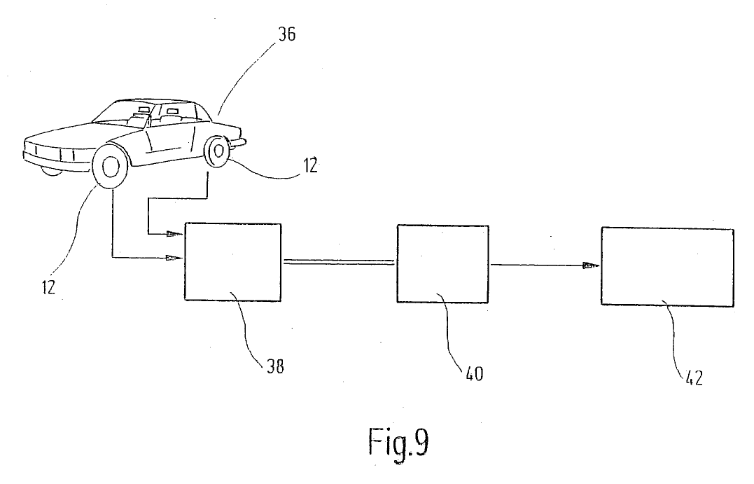

FIG. 9 shows an additional system overview which is useful for an understanding of the present invention. A vehicle 36 having tires 12 includes a tire control unit 38. This tire control unit communicates with an engine management system (ME7 or Cartronic, for example) via an interface (CAN, for example). Another interface is provided between this engine management system 40 and a unit 42, representing the engine, transmission and brakes of vehicle 36, for example. A memory module (e.g., an EEPROM), which continuously stores tire-specific information, may now be mounted in or on tires 12. An interface is also present between this module and tire control unit 38.

Based on a tire-specific encoding, it is possible to recognize, for example when a tire change is necessary. The mileage of tire 12 is acquired for this purpose. Considering the stored tire-specific data and variables that influence the service life of the tire, mileage and tire load, for example, it is thus possible to decide when a tire change is necessary.

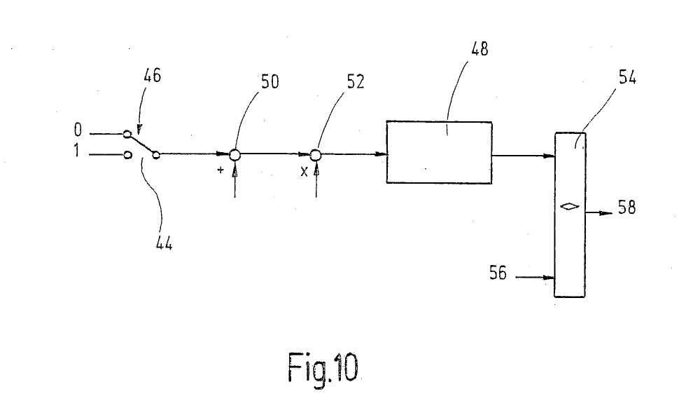

FIG. 10 shows a system block diagram to explain a system that determines when the service life of a tire has been reached. In the event the motor vehicle is used, switch 44 is shifted from position 0 to position 1 by switching means 46. In this case, values are supplied to an integrator 48. The result of integration identifies the service life of the tire. In addition, an offset value is injected at position 50. Such an offset may be injected, for example, when a braking intervention, i.e., an action influencing the service life of the tires, occurs. A weighting may also take place at position 52, for example, as a function of the tire temperature. The output values of integrator 48 are supplied to comparison means 54 where they are compared with a threshold value 56. Result 58 of the comparison means indicates whether or not the tire must be changed.

The system according to FIG. 10 operates in such a way that mileage and load are determined indirectly from existing signals, i.e., miles traveled, acceleration, tire slip or spinning of the tires, braking interventions, etc. using a service life model. The offset that is injected at position 50 or the weighting injected at position 52 must be adjusted by the application for the individual tire type and permanently stored in the electronic control unit.

The above description of the exemplary embodiments according to the present invention is only intended to illustrate and not limit the invention. Various changes and modifications are possible within the scope of the invention without departing from the scope of the invention and its equivalents.

What is claimed is:

1. A system for monitoring properties of at least one tire (12) on a vehicle (36),
wherein
means are provided for storing information on the tires, the information representing properties of the tire (12), and
sensors (20, 22) are provided for acquiring the information.

2. The system as recited in claim 1,
wherein the driving response of the vehicle (36) is controlled based on the information acquired by the sensors (20, 22).

3. The system as recited in claim 1 or 2,
wherein the driving response of the vehicle (36) is regulated based on the information acquired by the sensors (20, 22).

4. The system as recited in one of the preceding claims,
wherein
means for storing the information are implemented by modifying the acquiring elements (24, 26, 28, 30) of a tire sensor situated on the tires (12) and
a vehicle dynamics control system (16) is provided to evaluate the information, the vehicle dynamics control system processing the information from tire sensors (20, 22).

5. The system as recited in one of the preceding claims,
wherein the information represents the slip requirement of the tire (12).

6. The system as recited in one of the preceding claims,
wherein the information represents the maximum allowed vehicle longitudinal speed for the tire (12).

7. The system as recited in one of the preceding claims,
wherein the information represents the manufacturing date of the tire (12).

8. The system as recited in one of the preceding claims,
wherein it is possible to determine if the tire (12) is approved for the vehicle as a function of the information.

9. The system as recited in one of the preceding claims,
wherein it is possible to determine the tire wear as a function of the information.

10. The system as recited in one of the preceding claims,
wherein it is possible to activate a speed limiting device as a function of the information.

11. The system as recited in one of the preceding claims,
wherein it is possible to activate a vehicle immobilizing device as a function of the information.

12. The system as recited in one of the preceding claims,
wherein it is possible to output driver information as a function of the information.

13. The system as recited in one of the preceding claims,
wherein a memory unit affixed to the tire (12) is provided for storing the information.

14. The system as recited in one of the preceding claims,
wherein
an applicable service life model of the tire (12) is inferred from the information,
values of variables which influence the life of the tire (12) are acquired during the life of the tire (12),
the values are used as input values for the service life model and
the service life model is used to decide if the tire has exceeded its service life.

15. A method for monitoring properties of at least one tire (12) on a vehicle (36),
wherein
information is stored on the tire, the information representing information of the tire (12) and
the information is acquired by sensors (20, 22).

16. The method as recited in claim 15,
wherein the driving response of the vehicle (36) is controlled based on the information acquired by the sensors (20, 22).

17. The method as recited in claim 15 or 16,
wherein the driving response of the vehicle (36) is regulated based on the information acquired by the sensors (20, 22).

18. The method as recited in one of claims 15 through 17,
wherein
the information is stored by modifying the acquiring elements (24, 26, 28, 30) of a tire sensor situated on the tire and
the information is evaluated within a vehicle dynamics control system (16) which processes the information from tire sensors (20, 22).

19. The method as recited in one of claims 15 through 18,
wherein the information represents the slip requirement of the tire (12).

20. The method as recited in one of claims 15 through 19,
wherein the information represents the maximum allowed vehicle longitudinal speed for the tire (12).

21. The method as recited in one of claims 15 through 20,
wherein the information represents the manufacturing date of the tire (12).

22. The method as recited in one of claims 15 through 21,
wherein it is possible to determine if the tire (12) is approved for the vehicle as a function of the information.

23. The method as recited in one of claims 15 through 22,
wherein it is possible to determine the tire wear as a function of the information.

24. The method as recited in one of claims 15 through 23,
wherein it is possible to activate a speed limiting device as a function of the information.

25. The method as recited in one of claims 15 through 24,
wherein it is possible to activate a vehicle immobilizing device as a function of the information.

26. The method as recited in one of claims 15 through 25,
wherein it is possible to output driver information as a function of the information.

27. The method as recited in one of claims 15 through 26,
wherein the information is stored in an electronic memory unit affixed to the tire (12).

28. The method as recited in one of claims 15 through 27,
wherein
an applicable service life model of the tire (12) is inferred from the information,
values of variables which influence the life of the tire (12) are acquired during the life of the tire (12),
the values are used as input values for the service life model and
the service life model is used to decide if the tire has exceeded its service life.
